(19) United States
(12) Patent Application Publication
(10) Pub. No.: US 2013/0309580 A1
(43) Pub. Date: Nov. 21, 2013

(54) COATED ACTIVE MATERIAL, BATTERY, AND METHOD FOR PRODUCING COATED ACTIVE MATERIAL

(71) Applicant: Seiji Tomura, Susono-shi (JP)

(72) Inventor: Seiji Tomura, Susono-shi (JP)

(73) Assignee: TOYOTA JIDOSHA KABUSHIKI KAISHA, Toyota-shi, Aichi (JP)

(21) Appl. No.: 13/982,040

(22) PCT Filed: Feb. 4, 2011
(86) PCT No.: PCT/JP2011/052404

§ 371 Date: Jul. 26, 2013

(51) Int. Cl. H01M 4/36

(52) U.S. Cl. CPC H01M 4/366
USPC 429/304

(57) ABSTRACT

The problem of the present invention is to provide a coated active material capable of restraining interface resistance from increasing. The present invention solves the above-mentioned problem by providing a coated active material used for a battery, including an active material and a coating layer for coating the above-mentioned active material, characterized in that the above-mentioned coating layer includes a substance containing a tungsten element.

### TECHNICAL FIELD

The present invention relates to a coated active material capable of restraining interface resistance from increasing.

### BACKGROUND ART

In accordance with a rapid spread of information relevant apparatuses and communication apparatuses such as a personal computer, a video camera and a portable telephone in recent years, the development of a battery to be utilized as a power source thereof has been emphasized. The development of a high-output and high-capacity battery for an electric automobile or a hybrid automobile has been advanced also in the automobile industry. A lithium battery has been presently noticed from the viewpoint of a high energy density among various kinds of batteries.

Liquid electrolyte containing a flammable organic solvent is used for a presently commercialized lithium battery, so that the installation of a safety device for restraining temperature rise during a short circuit and the improvement in structure and material for preventing the short circuit are necessary therefor. On the contrary, a lithium battery all-solidified by replacing the liquid electrolyte with a solid electrolyte layer is conceived to intend the simplification of the safety device and be excellent in production cost and productivity for the reason that the flammable organic solvent is not used in the battery.

In the field of such a solid state battery, the intention of improving the performance of the solid state battery has been conventionally attempted while noticing an interface between an electrode active material and a solid electrolyte material. For example, in Patent Literature 1, it is disclosed that an oxide-based cathode active material is coated with lithium niobate. This technique is such that interface resistance between the oxide-based cathode active material and the solid electrolyte material is restrained from increasing at high temperature by improving uniformity of the thickness of lithium niobate.

### CITATION LIST

Patent Literature

Patent Literature 1: Japanese Patent Application Publication (JP-A) No. 2010-170715

### SUMMARY OF INVENTION

### Technical Problem

For example, an active material and a solid electrolyte material react to cause a high resistive layer at an interface therebetween, so that interface resistance between both increases. The active material and the solid electrolyte material have been conventionally restrained from reacting by the intervention of lithium niobate between the active material and the solid electrolyte material. However, in the case of using lithium niobate, from the material viewpoint, the problem is that interface resistance may not sufficiently be restrained from increasing, and interface resistance easily increases particularly under a long-term storage environment. The present invention has been made in view of the above-mentioned problem, and the main object thereof is to provide a coated active material capable of restraining interface resistance from increasing.

### Solution to Problem

In order to solve the above-mentioned problem, the present invention provides a coated active material used for a battery, comprising an active material and a coating layer for coating the above-mentioned active material, characterized in that the above-mentioned coating layer comprises a substance containing a tungsten element.

According to the present invention, the use of the substance containing a tungsten element as a material for the coating layer allows the coated active material capable of restraining interface resistance from increasing. In particular, interface resistance may be restrained from increasing after long-term storage.

In the above-mentioned invention, the above-mentioned active material is preferably an oxide active material. The reason therefor is to allow the high-capacity active material.

In the above-mentioned invention, the above-mentioned substance containing a tungsten element is preferably lithium tungstate. The reason therefor is to have Li ion conductivity. Thus, the coated active material useful for uses of a lithium battery may be obtained.

Also, the present invention provides a battery comprising a cathode active material layer containing a cathode active material, an anode active material layer containing an anode active material, and an electrolyte layer formed between the above-mentioned cathode active material layer and the above-mentioned anode active material layer, characterized in that at least one of the above-mentioned cathode active material and the above-mentioned anode active material is the above-mentioned coated active material.

According to the present invention, the use of the above-mentioned coated active material allows the battery which restrains interface resistance from increasing. In particular, interface resistance may be restrained from increasing after long-term storage.

In the above-mentioned invention, the above-mentioned coated active material preferably contacts with a sulfide solid electrolyte material. The reason therefor is that the sulfide solid electrolyte material is so high in reactivity that the effect of restraining interface resistance from increasing is easily performed in the case of using the coated active material.

Also, the present invention provides a method for producing a coated active material used for a battery, comprising a coating step of coating and drying an aqueous solution, in which a substance containing a tungsten element is dissolved, on an active material to thereby form a coating layer for coating the above-mentioned active material.

According to the present invention, the use of the aqueous solution, in which a substance containing a tungsten element is dissolved, allows the coated active material capable of restraining interface resistance from increasing.

In the above-mentioned invention, the method preferably comprises a hydrophilizing treatment step of performing hydrophilizing treatment on the surface of the above-mentioned active material before or simultaneously with the above-mentioned coating step. The reason therefor is that the hydrophilizing treatment causes surface tension on the active material surface to decrease and the above-mentioned aqueous solution adheres and spreads easily on the active material surface. As a result, there are the advantages that adhesive strength between the coating layer and the active material increases and contact area between the coating layer and the active material expands.

In the above-mentioned invention, the above-mentioned hydrophilizing treatment is preferably ultraviolet-light irradiation treatment or plasma treatment.

### Advantageous Effects of Invention

The present invention produces the effect such as to allow a coated active material capable of restraining interface resistance from increasing.

### BRIEF DESCRIPTION OF DRAWINGS

FIG. 1 is a schematic cross-sectional view showing an example of a coated active material of the present invention.

FIG. 2 is a schematic cross-sectional view showing an example of a power generating element of a battery of the present invention.

FIG. 3 is a schematic view showing an example of a method for producing a coated active material of the present invention.

FIG. 4 is a schematic view showing another example of a method for producing a coated active material of the present invention.

FIG. 5 is a schematic view showing another example of a method for producing a coated active material of the present invention.

FIGS. 6A and 6B are each an SEM image of a coated active material obtained in Examples 1 and 2.

FIG. 7 is a TEM image of a coated active material obtained in Example 1.

FIGS. 8A and 8B are each a result of EDX analysis of a coated active material obtained in Examples 1 and 2.

FIG. 9 is an evaluation result of resistance change of a solid state battery using a coated active material obtained in Example 1.

### DESCRIPTION OF EMBODIMENTS

A coated active material, a battery and a method for producing a coated active material of the present invention are hereinafter described in detail.

A. Coated active material

First, a coated active material of the present invention is described. The coated active material of the present invention is a coated active material used for a battery, comprising an active material and a coating layer for coating the above-mentioned active material, characterized in that the above-mentioned coating layer comprises a substance containing a tungsten element.

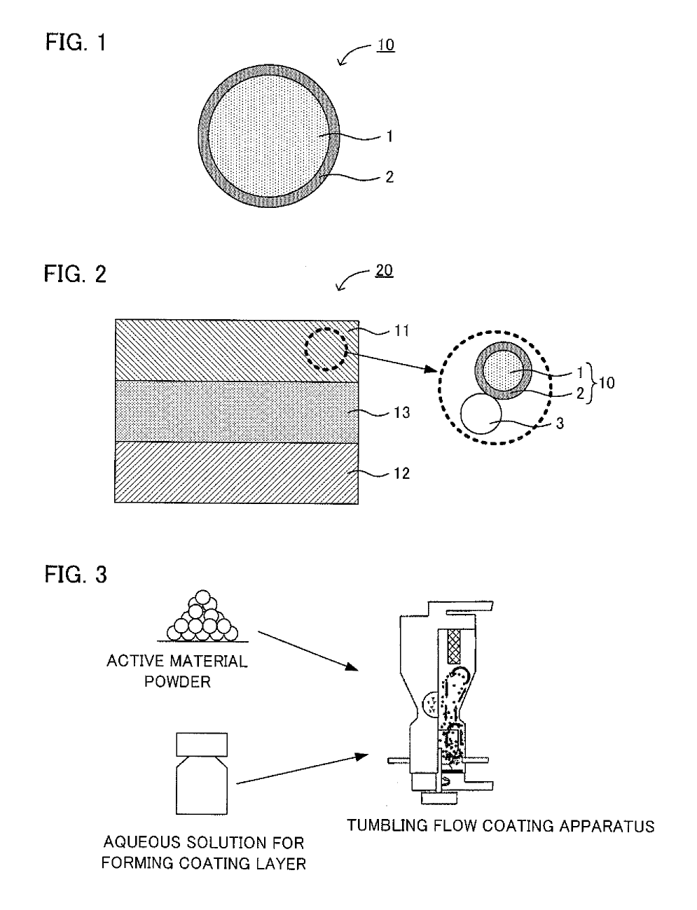

FIG. 1 is a schematic cross-sectional view showing an example of the coated active material of the present invention. A coated active material 10 shown in FIG. 1 comprises an active material 1 and a coating layer 2 for coating the active material 1. The coated active material 10 of the present invention is greatly characterized in that the coating layer 2 comprises a substance containing a tungsten element.

According to the present invention, the use of the substance comprising a tungsten element as a material for the coating layer allows the coated active material capable of restraining interface resistance from increasing. In particular, interface resistance may be restrained from increasing after long-term storage. As described above, a substance containing a niobium element such as lithium niobate has been conventionally used as a material for the coating layer; however, interface resistance may not sufficiently be restrained from increasing. On the contrary, in the present invention, the use of the substance comprising a tungsten element allows interface resistance to be further restrained from increasing. Also, the coated active material of the present invention has the coating layer comprising a substance containing a tungsten element, so that the coating layer intervenes between the active material and another substance contacting with the coated active material (electrolyte materials such as a solid electrolyte material, a liquid electrolyte and a polymer electrolyte material). Thus, the active material and another substance may be restrained from reacting and interface resistance may be restrained from increasing. Incidentally, the coated active material of the present invention may be used for not merely a solid state battery but also a liquid battery and a polymer battery.

The coated active material of the present invention is hereinafter described in each constitution.

1. Active material

First, the active material in the present invention is described. The active material in the present invention is an active material used in an electrode of a battery. For example, the active material used for a lithium secondary battery has the function of occluding and releasing Li ions.

The active material in the present invention is not particularly limited but examples thereof include an oxide active material. The reason therefor is to allow the high-capacity active material. Also, examples of the oxide active material used as a cathode active material of a lithium battery include an oxide active material represented by a general formula LiₓM_{y}O_{z} (M is a transition metallic element, x=0.02 to 2.2, y=1 to 2 and z=1.4 to 4). In the above-mentioned general formula, M is preferably at least one kind selected from the group consisting of Co, Mn, Ni, V and Fe, and more preferably at least one kind selected from the group consisting of Co, Ni and Mn. Specific examples of such an oxide active material include rock salt bed type active materials such as LiCoO₂, LiMnO₂, LiNiO₂, LiVO₂ and LiNi_{1/3}CO_{1/3}Mn_{1/3}O₂, and spinel type active materials such as LiMn₂O₄ and Li(Ni_{0.5}Mn_{1.5})O₄. Also, examples of the oxide active material except the above-mentioned general formula of LiₓM_{y}O_{z} include olivine type active materials such as LiFePO₄ and LiMnPO₄, and Si-containing active materials such as Li₂FeSiO₄ and Li₂MnSiO₄.

On the other hand, examples of the oxide active material used as an anode active material of a lithium battery include Nb₂O₅, Li₄Ti₅O₁₂ and SiO. Incidentally, the active material in the present invention may be used as a cathode active material or an anode active material. The reason therefor is that whether the active material becomes a cathode active material or an anode active material is determined by electrical potential of the active materials to be combined.

Examples of the shape of the active material include a particulate shape, and preferably a perfectly spherical shape or an elliptically spherical shape, above all. Also, in the case where the active material is in a particulate shape, the average particle diameter thereof (D₅₀) is, for example, preferably within a range of 0.1 μm to 50 μm.

2. Coating layer

Next, the coating layer in the present invention is described. The coating layer in the present invention coats the above-mentioned active material, and comprises a substance containing a tungsten element.

Examples of the substance comprising a tungsten element include a tungsten simple substance and a tungsten compound. The tungsten compound is not particularly limited but examples thereof include a tungsten oxide. In addition, examples of the tungsten oxide include a tungstate, a tungstic acid (H₂WO₄) and a tungstic oxide (WO₂, WO₃ and W₂O₅) . Examples of the tungstate include lithium tungstate (Li₂WO₄), sodium tungstate (Na₂WO₄) and calcium tungstate (CaWO₄). In particular, in the present invention, the substance containing a tungsten element is preferably lithium. tungstate (Li₂WO₄). The reason therefor is to have Li ion conductivity. Thus, the coated active material useful for uses of a lithium battery may be obtained.

The thickness of the coating layer may be a thickness such as to be capable of restraining the active material and another substance (electrolyte materials such as a solid electrolyte material, a liquid electrolyte and a polymer electrolyte material) from reacting; and for example, preferably within a range of 1 nm to 500 nm, more preferably within a range of 2 nm to 100 nm, and far more preferably within a range of 3 nm to 50 nm. The reason therefor is that too thin coating layer brings a possibility that the active material and another substance react, while too thick coating layer brings a possibility that ion conductivity deteriorates. Incidentally, the thickness of the coating layer may be determined by observation with a transmission electron microscope (TEM). Also, the coverage factor of the coating layer on the active material surface is preferably high from the viewpoint of restraining interface resistance from increasing; and specifically, preferably 50% or more, and more preferably 80% or more. Also, the coating layer may coat the whole surface of the active material. Incidentally, the coverage factor of the coating layer may be determined by observation with a transmission electron microscope (TEM).

3. Coated active material

The coated active material of the present invention is ordinarily used for a battery. The battery is described in detail in the after-mentioned “B. Battery”. Also, a method for producing the coated active material is described in detail in the after-mentioned “C. Method for producing coated active material”. Also, general methods such as a sol-gel method, a mechano-fusion method, a CVD method and a PVD method may be used for obtaining the coated active material of the present invention.

B. Battery

Next, a battery of the present invention is described. The battery of the present invention is a battery comprising a cathode active material layer containing a cathode active material, an anode active material layer containing an anode active material, and an electrolyte layer formed between the above-mentioned cathode active material layer and the above-mentioned anode active material layer, characterized in that at least one of the above-mentioned cathode active material and the above-mentioned anode active material is the above-mentioned coated active material.

FIG. 2 is a schematic cross-sectional view showing an example of a power generating element of the battery of the present invention, specifically showing an example of a power generating element of a solid state battery. A power generating element 20 of the battery shown in FIG. 2 comprises a cathode active material layer 11, an anode active material layer 12 and a solid electrolyte layer 13 formed between the cathode active material layer 11 and the anode active material layer 12. In addition, the cathode active material layer 11 has a coated active material 10 provided with an active material 1 and a coating layer 2, and an electrolyte material 3.

According to the present invention, the use of the above-mentioned coated active material allows the battery which restrains interface resistance from increasing. In particular, interface resistance may be restrained from increasing after long-term storage. Also the use of the above-mentioned coated active material allows the capacity of the battery to be restrained from decreasing during storage.

The battery of the present invention is hereinafter described in each constitution.

1. Cathode active material layer

First, the cathode active material layer in the present invention is described. The cathode active material layer in the present invention is a layer containing at least the cathode active material, and may further contain at least one of a solid electrolyte material, a conductive material and a binder as required.

The cathode active material in the present invention is preferably the coated active material described in the above-mentioned “A. Coated active material”. The reason therefor is to allow interface resistance to be restrained from increasing. Also, for example, in the case where the anode active material is the above-mentioned coated active material, the cathode active material may not be the coated active material. The content of the cathode active material in the cathode active material layer is, for example, preferably within a range of 10% by weight to 99% by weight, and more preferably within a range of 20% by weight to 90% by weight.

The cathode active material layer preferably contains a solid electrolyte material. The reason therefor is to allow ion conductance in the cathode active material layer to be improved. Incidentally, the solid electrolyte material contained in the cathode active material layer is the same as the solid electrolyte material described in the after-mentioned “3. Electrolyte layer”. The content of the solid electrolyte material in the cathode active material layer is, for example, preferably within a range of 1% by weight to 90% by weight, and more preferably within a range of 10% by weight to 80% by weight.

Also, in the case where the cathode active material is the above-mentioned coated active material, the coated active material preferably contacts with a sulfide solid electrolyte material. The reason therefor is that the sulfide solid electrolyte material is so high in reactivity that the effect of restraining interface resistance from increasing is easily performed in the case of using the coated active material. Also, in this case, the active material supporting the coating layer is preferably an oxide active material. The reason therefor is that the sulfide solid electrolyte material and the oxide active material react easily and this reaction may be restrained by the coating layer. Examples of an aspect such that the coated active material and the sulfide solid electrolyte material contact include an aspect such that the cathode active material layer contains both the coated active material and the sulfide solid electrolyte material, and both of them contact in the cathode active material layer. Also, other examples of the above-mentioned aspect include an aspect such that the cathode active material layer contains the coated active material, the solid electrolyte layer contains the sulfide solid electrolyte material, and both of them contact at an interface between the cathode active material layer and the solid electrolyte layer.

The cathode active material layer in the present invention may further contain a conductive material. The addition of the conductive material allows electrical conductivity of the cathode active material layer to be improved. Examples of the conductive material include acetylene black, Ketjen Black and carbon fiber. Also, the cathode active material layer may further contain a binder. Examples of the binder include fluorine-containing binders such as PTFE and PVDE. Also, the thickness of the cathode active material layer varies with kinds of an intended battery, and is preferably within a range of 0.1 μm to 1000 μm, for example.

2. Anode active material layer

Next, the anode active material layer in the present invention is described. The anode active material layer in the present invention is a layer containing at least the anode active material, and may further contain at least one of a solid electrolyte material, a conductive material and a binder as required.

The anode active material in the present invention is preferably the coated active material described in the above-mentioned “A. Coated active material”. The reason therefor is to allow interface resistance to be restrained from increasing. Also, for example, in the case where the cathode active material is the above-mentioned coated active material, the anode active material may not be the coated active material. Examples of the anode active material except the coated active material include a metal active material and a carbon active material. Examples of the metal active material include In, Al, Si, and Sn. On the other hand, examples of the carbon active material include graphite such as mesocarbon microbeads (MCMB) and high orientation property graphite (HOPG), and amorphous carbon such as hard carbon and soft carbon. Incidentally, SiC may be used as the anode active material. The content of the anode active material in the anode active material layer is, for example, preferably within a range of 10% by weight to 99% by weight, and more preferably within a range of 20% by weight to 90% by weight.

The anode active material layer preferably contains a solid electrolyte material. The reason therefor is to allow ion conductance in the anode active material layer to be improved. Incidentally, the solid electrolyte material contained in the anode active material layer is the same as the solid electrolyte material described in the after-mentioned “3 . Electrolyte layer”. The content of the solid electrolyte material in the anode active material layer is, for example, preferably within a range of 1% by weight to 90% by weight, and more preferably within a range of 10% by weight to 80% by weight.

Also, in the case where the anode active material is the above-mentioned coated active material, the coated active material preferably contacts with a sulfide solid electrolyte material. The reason therefor is that the sulfide solid electrolyte material is so high in reactivity that the effect of restraining interface resistance from increasing is easily performed in the case of using the coated active material . Also, in this case, the active material supporting the coating layer is preferably an oxide active material. The reason therefor is that the sulfide solid electrolyte material and the oxide active material react easily and this reaction may be restrained by the coating layer. An aspect such that the coated active material and the sulfide solid electrolyte material contact is the same as the above-mentioned case in the cathode active material; therefore, the description herein is omitted.

Incidentally, the conductive material and the binder used for the anode active material layer are also the same as the above-mentioned case in the cathode active material layer. Also, the thickness of the anode active material layer varies with kinds of an intended battery, and is preferably within a range of 0.1 μm to 1000 μm, for example.

3. Electrolyte layer

Next, the electrolyte layer in the present invention is described. The electrolyte layer in the present invention is a layer formed between the above-mentioned cathode active material layer and the above-mentioned anode active material layer. Ion conduction between a cathode active material and an anode active material is performed through the electrolyte contained in the electrolyte layer. The form of the electrolyte layer is not particularly limited but examples thereof include a solid electrolyte layer, a liquid electrolyte layer and a gel electrolyte layer.

The solid electrolyte layer is a layer containing the solid electrolyte material. Examples of the solid electrolyte material include a sulfide solid electrolyte material and an oxide solid electrolyte material, and preferably a sulfide solid electrolyte material, above all. The reason therefor is to be high in ion conductivity as compared with an oxide solid electrolyte material. Also, a sulfide solid electrolyte material is so higher in reactivity than an oxide solid electrolyte material as to react easily with the active material and form a high resistive layer easily at an interface with the active material. Thus, the effect of restraining interface resistance from increasing is easily performed in the case of using the coated active material.

Examples of the sulfide solid electrolyte material used for a lithium battery include Li₂S-P₂S₅, Li₂S-P₂S₅-LiI, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B₂S₃, Li₂S-P₂S₅-ZₘSₙ (“m” and “n” are positive numbers; “Z” is any of Ge, Zn and Ga.), Li₂S-GeS₂, Li₂S-SiS₂-Li₃PO₄, and Li₂S-SiS₂-LiₓMO_{y} (“x” and “y” are positive numbers; M is any of P, Si, Ge, B, Al, Ga and In). Incidentally, the description of the above-mentioned “Li₂S-P₂S₅” signifies the sulfide solid electrolyte material obtained by using a raw material composition containing Li₂S and P₂S₅, and other descriptions signify similarly.

Also, in the case where the sulfide solid electrolyte material is obtained by using a raw material composition containing Li₂S and P₂S₅, the ratio of Li₂S to the total of Li₂S and P₂S₅ is, for example, preferably within a range of 70 mol % to 80 mol % , more preferably within a range of 72 mol % to 78 mol % , and far more preferably within a range of 74 mol % to 76 mol %. The reason therefor is to allow the sulfide solid electrolyte material having an ortho-composition or a composition in the neighborhood of it and allow the sulfide solid electrolyte material with high chemical stability. Here, ortho generally signifies oxo acid which is the highest in degree of hydration among oxo acids obtained by hydrating the same oxide. In the present invention, a crystal composition to which Li₂S is added most among sulfides is called an ortho-composition. Li₃PS₄ corresponds to the ortho-composition in the Li₂S-P₂S₅ system. In the case of an Li₂S-P₂S₅-based sulfide solid electrolyte material, the ratio of Li₂S and P₂S₅ such as to allow the ortho-composition is Li₂S : P₂S₅ =75 : 25 on a molar basis. Incidentally, also in the case of using Al₂S₃ or B₂S₃ instead of P₂S₅ in the above-mentioned raw material composition, the preferable range is the same. Li₃AlS₃ corresponds to the ortho-composition in the Li₂S-Al₂S₃ system and Li₃BS₃ corresponds to the ortho-composition in the Li₂S-B₂S₃ system. [0049]

Also, in the case where the sulfide solid electrolyte material is obtained by using a raw material composition containing Li₂S and SiS₂, the ratio of Li₂S to the total of Li₂S and SiS₂ is, for example, preferably within a range of 60 mol % to 72 mol % , more preferably within a range of 62 mol % to 70 mol %, and far more preferably within a range of 64 mol % to 68 mol %. The reason therefor is to allow the sulfide solid electrolyte material having an ortho-composition or a composition in the neighborhood of it and allow the sulfide solid electrolyte material with high chemical stability. Li₄SiS₄ corresponds to the ortho-composition in the Li₂S-SiS₂ system. In the case of an Li₂S-SiS₂-based sulfide solid electrolyte material, the ratio of Li₂S and SiS₂ such as to allow the ortho-composition is Li₂S:SiS₂=66.6:33.3 on a molar basis. Incidentally, also in the case of using GeS₂ instead of SiS₂ in the above-mentioned raw material composition, the preferable range is the same. Li₄GeS₄ corresponds to the ortho-composition in the Li₂S-GeS₂ system.

Also, in the case where the sulfide solid electrolyte material is obtained by using a raw material composition containing LiX (X-Cl, Br and I), the ratio of LiX is, for example, preferably within a range of 1 mol % to 60 mol %, more preferably within a range of 5 mol % to 50 mol %, and far more preferably within a range of 10 mol % to 40 mol %.

Also, the sulfide solid electrolyte material may be sulfide glass, crystallized sulfide glass, or a crystalline material (a material obtained by a solid phase method).

The average particle diameter (D₅₀) of the sulfide solid electrolyte material is not particularly limited but preferably 40 μm or less, more preferably 20 μm or less, and far more preferably 10 μm or less. The reason therefor is to easily intend to make the solid electrolyte layer into a thin film and to improve filling factor of the solid electrolyte layer and the electrode active material layer. On the other hand, the above-mentioned average particle diameter is preferably 0.01 μm or more, and more preferably 0.1 μm or more. Incidentally, the above-mentioned average particle diameter may be determined by a particle size distribution meter, for example. Also, in the case where the sulfide solid electrolyte material is an Li ion conductor, Li ion conductivity at normal temperature is, for example, preferably 1×10⁻⁵ S/cm or mare, and more preferably 1×10⁻⁴ S/ cm or more.

The thickness of the solid electrolyte layer is not particularly limited but is, for example, preferably within a range of 0.1 μm to 1000 μm, and more preferably within a range of 0.1 μm to 300 μm.

Meanwhile, the liquid electrolyte layer is ordinarily a layer obtained by using a nonaqueous liquid electrolyte. The nonaqueous liquid electrolyte ordinarily contains a metallic salt and a nonaqueous solvent. Kinds of the metallic salt are preferably selected properly in accordance with kinds of batteries. Examples of the metallic salt used for a lithium battery include inorganic lithium salts such as LfPF₆, LiClO₄ and LiAsF₆; and organic lithium salts such as LiCF₃SO₃, LiN(CF₃SO₂)₂, LiN(C₂F₅SO₂)₂ and LiC(CF₃SO₂)₃. Examples of the nonaqueous solvent include ethylene carbonate (EC), propylene carbonate (PC), dimethyl carbonate (DMC), diethyl carbonate (DEC), ethyl methyl carbonate (EMC), butylene carbonate (BC), γ-butyrolactone, sulfolane, acetonitrile, 1,2-dimethoxymethane, 1,3-dimethoxypropane, diethyl ether, tetrahydrofuran, 2-methyltetrahydrofuran, and mixtures thereof. The concentration of the metallic salt in the nonaqueous liquid electrolyte is, for example, within a range of 0. 5 mol/L to 3 mol/L. Incidentally, in the present invention, a low-volatile liquid such as an ionic liquid may be used as the nonaqueous liquid electrolyte. Also, a separator may be disposed between the cathode active material layer and the anode active material layer.

4. Other constitutions

The battery of the present invention comprises at least the above-mentioned cathode active material layer, anode active material layer and electrolyte layer, ordinarily further comprises a cathode current collector for collecting currents from the cathode active material layer and an anode current collector for collecting currents from the anode active material layer. Examples of a material for the cathode current collector include SUS, aluminum, nickel, iron, titanium and carbon. On the other hand, examples of a material for the anode current collector include SUS, copper, nickel and carbon. Also, factors such as the thickness and shape of the cathode current collector and the anode current collector are preferably selected properly in accordance with uses of the battery. Also, a general battery case may be used for a battery case used for the present invention and examples thereof include a battery case made of SUS.

5. Battery

Examples of kinds of the battery of the present invention include a lithium battery, a sodium battery, a magnesium battery and a calcium battery; and above all, preferably a lithium battery. Also, the battery of the present invention may be a primary battery or a secondary battery, and preferably a secondary battery among them. The reason therefor is to be repeatedly charged and discharged and be useful as a car-mounted battery, for example. Examples of the shape of the battery of the present invention include a coin shape, a laminate shape, a cylindrical shape and a rectangular shape. Also, a producing method for the battery of the present invention is not particularly limited if the method is a method such as to allow the above-mentioned battery, but the same method as a producing method for a general battery may be used.

C. Method for producing coated active material

Next, a method for producing a coated active material of the present invention is described. The method for producing a coated active material of the present invention is a method for producing a coated active material used for a battery, comprising a coating step of coating and drying an aqueous solution, in which a substance containing a tungsten element is dissolved, on an active material to thereby form a coating layer for coating the above-mentioned active material.

FIG. 3 is a schematic view showing an example of the method for producing a coated active material of the present invention. In FIG. 3, active material powder (such as oxide active material powder) and an aqueous solution for forming a coating layer, in which a substance containing a tungsten element (such as lithium tungstate) is dissolved, are prepared. Next, the aqueous solution for forming a coating layer is gradually sprayed on the surface of the active material powder by using a tumbling flow coating apparatus. Thereafter, moisture is vaporized by drying to obtain a coated active material in which a coating layer is formed on the surface of the active material.

According to the present invention, the use of the aqueous solution, in which a substance containing a tungsten element is dissolved, allows the coated active material capable of restraining interface resistance from increasing. In a conventional sol-gel method, alkoxide is used as a material for forming a coating layer and synthesizing process is complicated. On the contrary, in the present invention, the aqueous solution for forming a coating layer may be produced only by dissolving a substance containing a tungsten element in water, and simple process allows a coating layer to be uniformly formed on the surface of the active material. That is to say, a coating layer may be uniformly formed by dissolving and precipitating a substance containing a tungsten element.

The method for producing a coated active material of the present invention is hereinafter described in each step.

1. Coating step

The coating step in the present invention is step of coating and drying an aqueous solution, in which a substance containing a tungsten element is dissolved, on an active material to thereby form a coating layer for coating the above-mentioned active material. The active material and the substance containing a tungsten element are the same as the contents described in the above-mentioned “A. Coated active material”; therefore, the description herein is omitted.

The aqueous solution in the present invention is ordinarily an aqueous solution for forming a coating layer and contains a substance containing a tungsten element. The concentration of a substance containing a tungsten element, which is dissolved in the above-mentioned aqueous solution, is not particularly limited if the concentration is a concentration such as to allow a desired coating layer, but is, for example, preferably within a range of 0.02 mol/L to 0.5 mol/L, and more preferably within a range of 0.05 mol/L to 0.3 mol/L. The reason therefor is that too low concentration causes much time to be spent in forming a coating layer, while too high concentration causes the preparation of the aqueous solution to become difficult.

Also, in preparing the above-mentioned aqueous solution, a substance containing a tungsten element is preferably dissolved in water while heating water. The reason therefor is that dissolution rate in water becomes large. Heating temperature is, for example, preferably within a range of 20° C. to 100° C., and more preferably within a range of 50° C. to 90° C. in the case of dissolving a substance containing a tungsten element at normal pressure. Also, in the present invention, a substance containing a tungsten element is preferably dissolved in water under a hydrothermal condition environment. The reason therefor is that dissolution rate in water becomes larger. The hydrothermal condition environment signifies an environment such as to heat in a closed vessel and make the pressure in the vessel higher than atmospheric pressure. Heating temperature in the hydrothermal condition environment is, for example, preferably within a range of 100° C. to 240° C., more preferably within a range of 180° C. to 220° C.

Examples of a method for coating the above-mentioned aqueous solution on the active material include a tumbling flow coating method, a spray method, an immersion method and a spray dryer method.

In the present invention, drying treatment is ordinarily performed after coating the above-mentioned aqueous solution on the surface of the active material. Thus, moisture contained in the above-mentioned aqueous solution is vaporized and a substance containing a tungsten element is precipitated on the surface of the active material. Drying temperature is not particularly limited if the temperature is a temperature higher than a temperature such as to vaporize water. Also, burning treatment may be performed in a temperature range in which the active material and the coating layer do not deteriorate.

2. Hydrophilizing treatment step

In the invention, the method preferably has hydrophilizing treatment step of performing hydrophilizing treatment on the surface of the above-mentioned active material before or simultaneously with the above-mentioned coating step. The reason therefor is that the hydrophilizing treatment causes surface tension on the active material surface to decrease and the above-mentioned aqueous solution adheres and spreads easily on the active material surface. As a result, there are the advantages that adhesive strength between the coating layer and the active material increases and contact area between the coating layer and the active material expands.

The hydrophilizing treatment is not particularly limited if the treatment is a treatment which may decrease surface tension on the active material surface, but examples thereof include ultraviolet-light irradiation treatment, plasma treatment, ion treatment, radiation treatment, excimer ultraviolet-light irradiation treatment, ozone treatment and ozone water treatment; above all, preferably ultraviolet-light irradiation treatment and plasma treatment from the viewpoint of handling.

The ultraviolet-light irradiation treatment is a treatment for irradiating ultraviolet rays on the active material to improve hydrophilic property on the active material surface. The wavelength of ultraviolet rays in ultraviolet-light irradiation is not particularly limited if the wavelength is a wavelength which may decrease surface tension on the active material surface, but is, for example, preferably within a range of 120 nm to 300 nm, and more preferably within a range of 150 nm to 260 nm. Also, the integrating irradiation amount of ultraviolet rays is, for example, preferably within a range of 5 mJ/cm² to 3000 mJ/cm², and more preferably within a range of 500 mJ/cm² to 1500 mJ/cm².

The plasma treatment is a treatment for discharging under a gas atmosphere at low pressure to thereby irradiate plasma generated by ionization effect of gas on the active material and then improve hydrophilic property on the active material surface. Examples of the above-mentioned discharge include corona discharge (high-pressure low-temperature plasma), arc discharge (high-pressure high-temperature plasma) and glow discharge (low-pressure low-temperature plasma). Also, examples of the gas to be used include nitrogen gas, argon gas, helium gas, neon gas, xenon gas and oxygen gas.

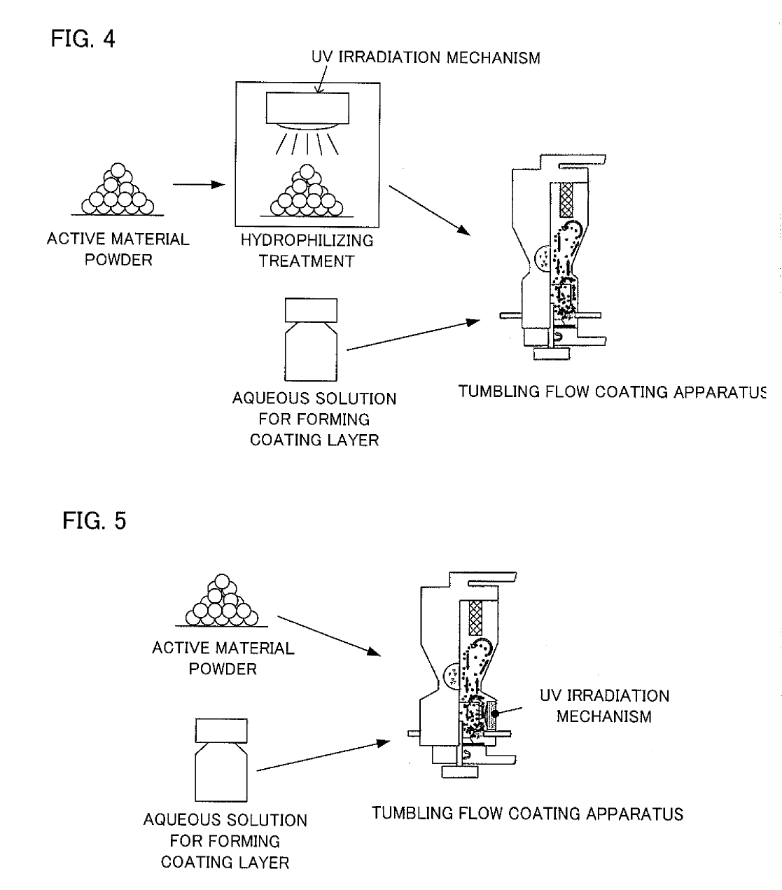

Also, in the present invention, as shown in FIG. 4, the hydrophilizing treatment may be performed for active material powder before the coating step. In FIG. 4, tumbling flow coating is performed by using the active material powder previously subject to the hydrophilizing treatment. The hydrophilizing treatment is preferably performed immediately before the tumbling flow coating for easily performing the effect of the hydrophilizing treatment. On the other hand, in the present invention, as shown in FIG. 5, the hydrophilizing treatment may be performed for the active material powder simultaneously with the coating step. In FIG. 5, a hydrophilizing treatment mechanism (such as a UV irradiation mechanism) is built in a tumbling flow coating apparatus, and the hydrophilizing treatment is performed for the active material simultaneously with the coating of the aqueous solution.

Incidentally, the present invention is not limited to the above-mentioned embodiments. The above-mentioned embodiments are exemplification, and any is included in the technical scope of the present invention if it has substantially the same constitution as the technical idea described in the claim of the present invention and offers similar operation and effect thereto.

### EXAMPLES

The present invention is described more specifically while showing examples hereinafter.

### Example 1

0.25 mol/L-aqueous solution of lithium tungstate (Li₂WO₄ manufactured by Alfa Aesar) was produced. On this occasion, a hydrothermal condition environment (heated to a temperature of 200° C. in a closed vessel) was adopted to improve dissolution rate of lithium tungstate. Next, LiNi_{1/3}Co_{1/3}Mn_{1/3}O₂ was prepared as an active material to coat the above-mentioned aqueous solution on the surface of the active material by using a tumbling flow coating apparatus (manufactured by Powrex Corp). Thereafter, the active material was dried under the conditions of 60° C. and reduced pressure to obtain a coated active material.

### Example 2

0.075 mol/L-aqueous solution of lithium tungstate (Li₂WO₄, manufactured by Alfa Aesar) was produced. On this occasion, the aqueous solution was heated under normal pressure so that the solution temperature became 80° C. to dissolve lithium tungstate. Next, LiNi_{1/3}Co_{1/3}Mn_{1/3}O₂ as an active material was immersed in this aqueous solution to thereafter vaporize water. Thereafter, moisture on the active material surface was completely removed while burning at 300° C. and drying under reduced pressure at 120° C. to obtain a coated active material.

### Evaluations

(SEM observation and TEM observation)

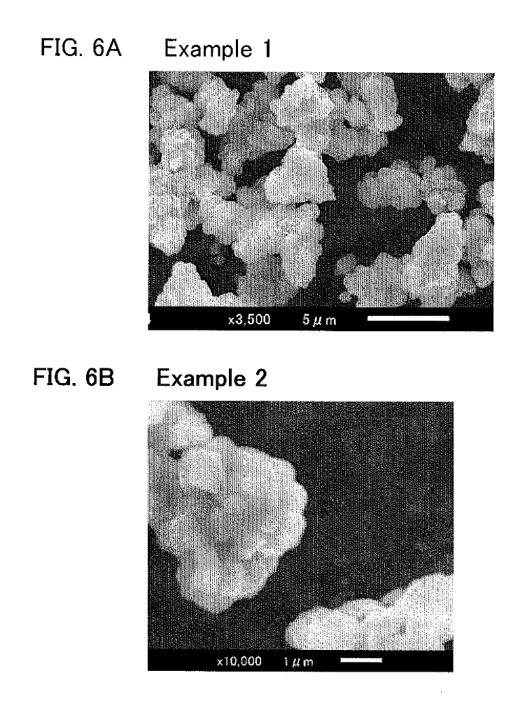

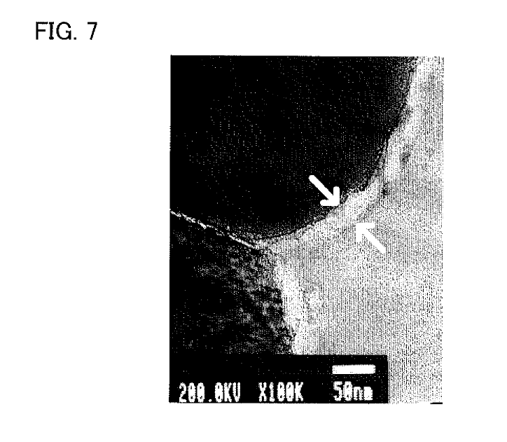

The coated active material obtained in Examples 1 and 2 was observed by a scanning electron microscope (SEM) . The results are shown in FIGS. 6A and 6B. Also, a cross section of the coated active material obtained in Example 1 was observed by a transmission electron microscope (TEM). The results are shown in FIG. 7. As shown in FIGS. 6 and 7, it was confirmed that a coating layer was formed on the surface of the active material. The thickness of the coating layer was approximately 3 nm to 30 nm through the results of the TEM image.

(EDX analysis)

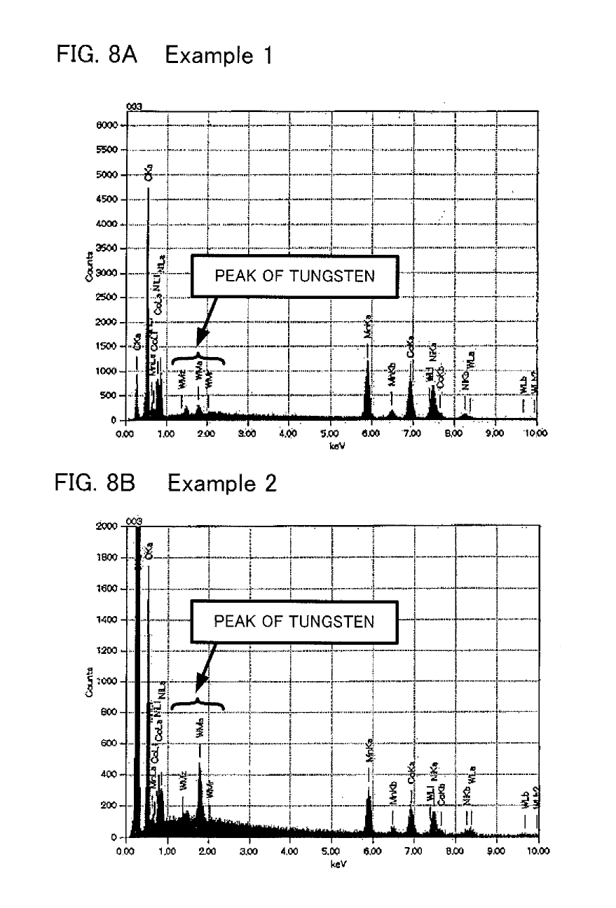

An energy-dispersive x-ray (EDX) analysis was performed for the coated active material obtained in Examples 1 and 2. The results are shown in FIGS. 8A and BB. As shown in FIGS. 8A and BB, a peak of tungsten was confirmed on the surface of the active material.

(Interface resistance measurement)

A solid state battery was produced by using the coated active material obtained in Example 1. First, Li₇P₃S₁₁ (a sulfide solid electrolyte material) was obtained by the same method as the method described in JP-A No. 2005-228570. Next, a power generating element 20 of the battery as shown in the above-mentioned FIG. 2 was produced by using a pressing machine. A mixture material in which the coated active material and Li₇P₃S₁₁ were mixed at a weight ratio of 7:3 was used for a cathode active material layer 11, an In foil with Li added was used for an anode active material layer 12, and Li₇P₃S₁₁ was used for a solid electrolyte layer 13. The solid state battery was obtained by using this power generating element.

On the other hand, a solid state battery was produced in the same manner as the above except for replacing the coated active material obtained in Example 1 with an active material in which LiNi_{1/3}Co_{1/3}Mn_{1/3}O₂ was coated with LiNbO₃. Also, a solid state battery was produced in the same manner as the above except for replacing the coated active material obtained in Example 1 with an active material having no coating layers (LiNi_{1/3}Co_{1/3}Mn_{1/3}O₂) . These solid state batteries were regarded as samples for comparison.

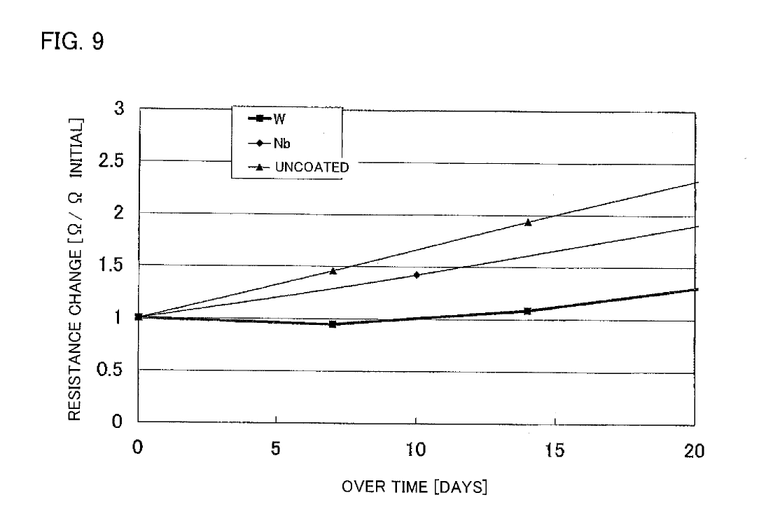

Interface resistance was measured by using the obtained solid state batteries. First, the solid state batteries were charged. With regard to the charge, constant-voltage charge at 4.1 V was performed for 12 hours. After the charge, interface resistance between the cathode active material layer and the solid electrolyte layer was measured by impedance measurement. The conditions of the impedance measurement were a voltage magnitude of 10 mV, a measuring frequency of 1 MHz to 0.01 Hz, and a temperature of 25° C. Thereafter, the batteries were stored at temperature of 60° C. to measure interface resistance between the cathode active material layer and the solid electrolyte layer after storing in the same manner. Interface resistance increasing rate (resistance change) was measured from the initial interface resistance value (zeroth-day interface resistance value) and the interface resistance value after storing. The results are shown in FIG. 9.

As shown in FIG. 9, the solid state battery comprising a substance containing a tungsten element in the coating layer had less resistance change as compared with the solid state battery comprising a substance containing a niobium element in the coating layer and the solid state battery comprising no coating layers.

### Example 3

0.25 mol/L-aqueous solution of lithium tungstate (Li₂WO₄, manufactured by Alfa Aesar) was produced. On this occasion, a hydrothermal condition environment (heated to a temperature of 200° C. in a closed vessel) was adopted to improve dissolution rate of lithium tungstate. Next, LiNi_{1/3}CO_{1/3}Mn_{1/3}O₂ was prepared as an active material. Next, ultraviolet rays with a wavelength of 172 nm were irradiated on the active material on the conditions of 50 mW/cm²×30 seconds to perform hydrophilizing treatment. Next, the above-mentioned aqueous solution was coated on the surface of the active material subject to the hydrophilizing treatment by using a tumbling flow coating apparatus (manufactured by Powrex Corp). Next, the active material was dried under the conditions of 60° C. and reduced pressure to obtain a coated active material.

### Example 4

An ultraviolet-light irradiation mechanism was incorporated into the tumbling flow coating apparatus to obtain a coated active material in the same manner as Example 3 except for irradiating ultraviolet rays by using this apparatus.

### REFERENCE SIGNS LIST

1 . . . active material

2 . . . coating layer

3 . . . electrolyte material

10 . . . coated active material

11 . . . cathode active material layer

12 . . . anode active material layer

13 . . . solid electrolyte layer

20 . . . power generating element of battery

1-8. (canceled)

9. A solid state battery comprising a cathode active material layer containing a cathode active material, an anode active material layer containing an anode active material, and a solid electrolyte layer formed between the cathode active material layer and the anode active material layer,
wherein at least one of the cathode active material and the anode active material is a coated active material,
the coated active material has an oxide active material and a coating layer for coating the oxide active material, and the coating layer comprises a substance containing a tungsten element, and
the coated active material contacts with a sulfide solid electrolyte material.

10. The solid state battery according to claim 9, wherein the substance containing a tungsten element is lithium tungstate.
